(19) United States
(12) Patent Application Publication
(10) Pub. No.: US 2015/0161923 A1
(43) Pub. Date: Jun. 11, 2015

(54) ELECTRONIC DEVICE, DISPLAY DEVICE, METHOD, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventor: Sayoko SAGA, Tokyo (JP)

(21) Appl. No.: 14/477,426

(22) Filed: Sep. 4, 2014

(30) Foreign Application Priority Data
Dec. 10, 2013 (JP) 2013-255125

(51) Int. Cl. G09F 27/00; H04N 21/426; G09F 9/302; H04N 5/262

(52) U.S. Cl. CPC G09F 27/00; H04N 5/2628; H04N 21/4263; G09F 9/3026

(57) ABSTRACT

According to one embodiment, an electronic device communicates with display devices configured to be combined with each other to display single image data. The electronic device includes an input controller and a transmitter. The input controller receives image data including both images of the display devices and images of identification information displayed on screens of the display devices. The transmitter transmits a first instruction for assigning at least one of display positions, rotation angles, and reduction and enlargement ratios of display ranges of the single image data to be displayed on the display devices. The first instruction is determined by using the image data.

### CROSS-REFERENCE TO RELATED APPLICATIONS

This application is based upon and claims the benefit of priority from Japanese Patent Application No. 2013-255125, filed Dec. 10, 2013, the entire contents of which are incorporated herein by reference.

### FIELD

Embodiments described herein relate generally to an electronic device, a display device, a method, and a computer program product.

### BACKGROUND

Conventionally, there has been known a technique called digital signage. According to the digital signage technique, information such as video images is displayed on display devices or the like as advertising media. Recently, there has been growing market on digital signage that employs display systems constituted of a plurality of display devices.

In the conventional technique, it is difficult to set video images displayed, respectively, on display devices in a display system that are used as the digital signage. Accordingly, a server that manages a plurality of display devices is used to set display ranges of the display devices.

### BRIEF DESCRIPTION OF THE DRAWINGS

A general architecture that'implements the various features of the invention will now be described with reference to the drawings. The drawings and the associated descriptions are provided to illustrate embodiments of the invention and not to limit the scope of the invention.

FIG. 1 is an exemplary diagram illustrating a conceptual example of a display system according to an embodiment;

FIG. 2 is an exemplary diagram illustrating a configuration example of the display system in the embodiment;

FIG. 3 is an exemplary block diagram illustrating a configuration example of a tablet and a first digital television display device in the embodiment;

FIG. 4 is an exemplary diagram illustrating display examples of video data displayed by using a position control function, a rotation function, and a reduction and enlargement function in the embodiment;

FIG. 5 is an exemplary schematic diagram illustrating a case in which a plurality of digital television display devices display markers, in the embodiment;

FIG. 6 is an exemplary diagram illustrating an example of a setting screen displayed on a touch panel of the tablet, and illustrating how the video data is displayed in the display system, in the embodiment;

FIG. 7 is an exemplary diagram illustrating an example of the digital television display devices that have changed a display mode of the video data in accordance with an instruction from the tablet in the embodiment; and

FIG. 8 is an exemplary flowchart illustrating a process of displaying the video data in the display system in the embodiment.

### DETAILED DESCRIPTION

In general, according to one embodiment, an electronic device is configured to communicate with display devices configured to be combined with each other to display single image data. The electronic device comprises an input controller and a transmitter. The input controller is configured to receive image data comprising both images of the display devices and images of identification information displayed on screens of the display devices. The transmitter is configured to transmit a first instruction for assigning at least one of display positions, rotation angles, and reduction and enlargement ratios of display ranges of the single image data to be displayed on the display devices. The first instruction is determined by using the image data.

Although a tablet is used as an electronic device in the present embodiment, the electronic device is not limited to the tablet, and may be a device such as a smartphone or a personal computer (PC) which can communicate with other devices via a network. Further, although a digital television display device is used as a display device in the present embodiment, it can be any device as long as the device comprises a display and can communicate with other devices via a network.

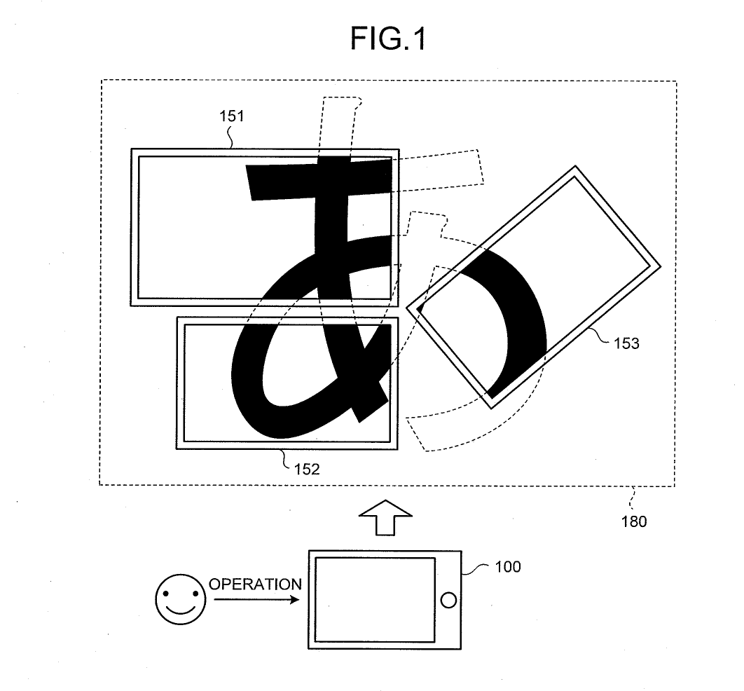

FIG. 1 is a diagram illustrating a schematic example of a display system according to the present embodiment. As illustrated in FIG. 1, the display system in the present embodiment comprises at least a plurality of digital television display devices 151 to 153 and a tablet 100.

As illustrated in FIG. 1, in the present embodiment, the digital television display devices 151 to 153 are disposed in certain positions to display portions of a video image corresponding to the respective positions, thereby implementing a big virtual screen. According to the present embodiment, a user can set the virtual screen in real time by operating the tablet 100, thereby facilitating the setting of the virtual screen and reducing setting loads.

When a plurality of display devices constitute one virtual screen in a conventional display system for signage, the display devices only receive and output video data, thus another device is required to perform processing (such as trimming and changing of display positions) on a video image for displaying video data corresponding to the positions of the display devices.

In other words, in order to change the video image, the other device (such as a video image output device) is used to perform processing (such as trimming and changing of display positions) to make the video data suitable for each of the display devices connected to the other device, and the other device then outputs the video data to each of the display devices. Thus, the conventional display devices only receive and output video data, and cannot change the size or position of the video data flexibly by, for example, user's operations.

In the present embodiment, the digital television display devices 151 to 153 perform processing on received video data depending on the relative positions of the digital television display devices. This allows a video image output device (that outputs video data to the digital television display devices 151 to 153) not to perform processing on the video data, thereby reducing loads on the video image output device.

Digital signage employs a conspicuous layout in many cases in order to attract people's attention to a structure on which advertisements are displayed. When a plurality of display devices are arranged in such a conspicuous layout to constitute one virtual screen, it is difficult to set display ranges for the respective display devices.

According to the present embodiment, the tablet 100 is used to perform setting on video data displayed on the digital television display devices 151 to 153, so that the user can easily set display ranges of the video data for the respective digital television display devices even when a conspicuous layout is employed.

The tablet 100 sets an output range 180 of a virtual screen to which video data is output. The tablet 100 specifies certain ranges of the video data to be projected on the output range 180 of a virtual screen based on the output range 180 of the virtual screen and relative positions of the digital television display devices 151 to 153. Consequently, the digital television display devices 151 to 153 display the respective ranges.

According to the present embodiment, the output range 180 of a virtual screen can be adjusted from the tablet 100. This enables a user to adjust video data displayed in a display system comprising at least the digital television display devices 151 to 153 by operating the tablet 100.

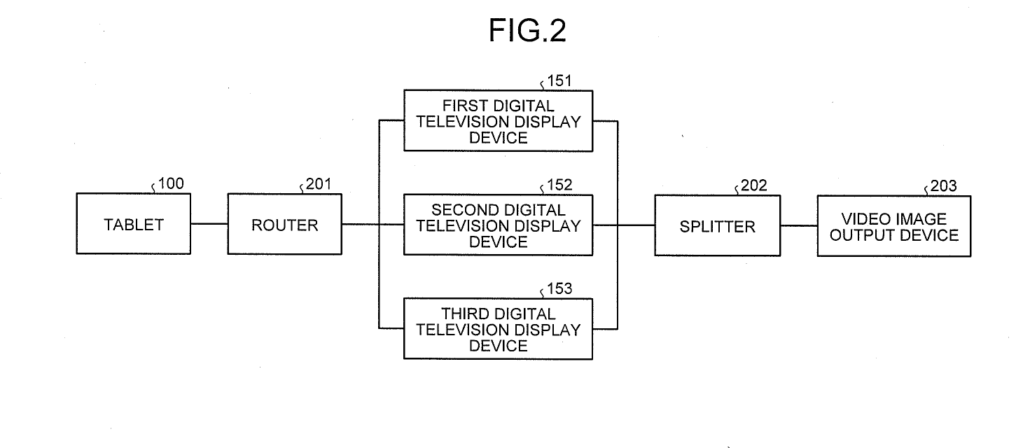

FIG. 2 is a diagram illustrating a configuration example of the display system according to the present embodiment. As illustrated in FIG. 2, the display system comprises the tablet 100, a router 201, a first digital television display device 151, a second digital television display device 152, a third digital television display device 153, a splitter 202, and a video image output device 203.

The router 201 is a communication device that is used to relay data among the tablet 100, the first digital television display device 151, the second digital television display device 152, and the third digital television display device 153.

The tablet 100 is connected with the router 201 via wireless or wired communication, and is capable of transmitting and receiving data to and from the first digital television display device 151, the second digital television display device 152, and the third digital television display device 153, via the router 201.

The video image output device 203 transmits video data to the first digital television display device 151, the second digital television display device 152, and the third digital television display device 153 via the splitter 202. In the present embodiment, because the video image output device 203 transmits video data via the splitter 202, the first digital television display device 151, the second digital television display device 152, and the third digital television display device 153 receive the same video data.

In other words, the video image output device 203 according to the present embodiment outputs the same video data to a plurality of digital television display devices, and the digital television display devices performs processing on the video data so that they can display video data corresponding to a position at which each digital television display device is disposed. On the other hand, a conventional video image output device transmits video data that has been trimmed according to the positions at which the first digital television display device 151, the second digital television display device 152, and the third digital television display device 153 are disposed. Thus, the video image output device 203 can reduce loads when transmitting video data to a plurality of digital television display devices. The video data transmitted by the video image output device 203 is not limited to video data of a certain kind, but may be, for example, video data received via digital broadcasting, or video data stored in a storage module or a storage medium.

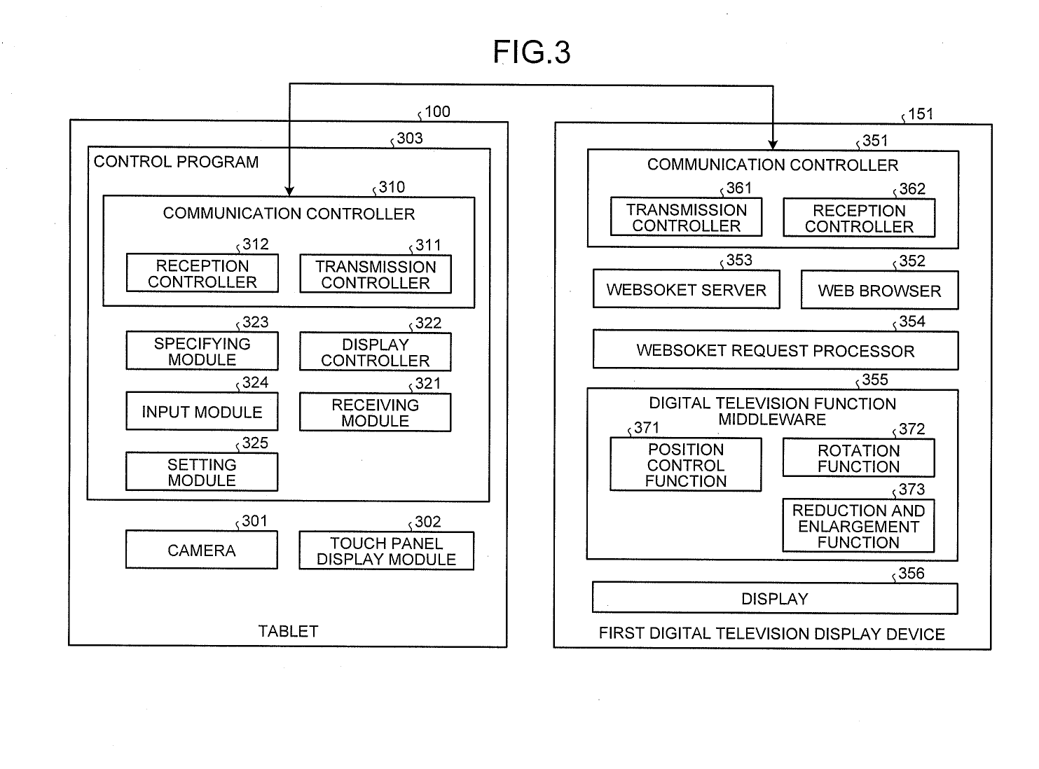

FIG. 3 is a block diagram illustrating a configuration example of the tablet 100 and the first digital television display device 151 according to the present embodiment. As illustrated in FIG. 3, the tablet 100 is an electronic device that comprises a camera 301, a touch panel display 302, and a control program 303, and also comprises a communication interface communicable with the digital television display devices 151 to 153 that are combined with each other to display single video data.

The camera 301 is an image acquiring device comprising an image acquiring element such as a charge coupled device (CCD) or a complementary metal-oxide semiconductor (CMOS). The camera 301 in the present embodiment is used to acquire an image of an environment comprising the digital television display devices 151 to 153.

The touch panel display 302 comprises a touch panel and a display screen (display) such as a liquid crystal display (LCD) or an organic electroluminescence (EL) display. The touch panel display 302 is capable of displaying various types of information on the display screen and of detecting a position (touch position) on a display region of the display screen.

The control program 303 is a computer program for performing setting when a video image is displayed in the display system. The control program 303 is executed by a CPU, for example, installed in the tablet 100 to implement configurations in the control program 303. In other words, the CPU (not illustrated) of the tablet 100 executes the control program 303 to implement a communication controller 310, a receiving module 321, a display controller 322, a specifying module 323, an input module 324, and a setting module 325.

The communication controller 310 comprises a reception controller 312 and a transmission controller 311, and controls transmission and reception of data to and from the digital television display devices 151 to 153.

The reception controller 312 controls reception of data from the digital television display devices 151 to 153.

The transmission controller 311 controls transmission of data to the digital television display devices 151 to 153.

The display controller 322 controls the touch panel display 302 to display data. The display controller 322, for example, controls the touch panel display 302 to display image data input by the input module 324.

The input module 324 inputs image data acquired by the camera 301.

For example, after the digital television display devices 151 to 153 display, respectively, pieces of identification information (hereinafter also referred to as markers) for specifying relative positions of the digital television display devices 151 to 153, the camera 301 acquires images of the digital television display devices 151 to 153 and markers displayed, respectively, on the digital television display devices 151 to 153. The input module 324 inputs image data generated by acquiring the images by the camera 301. The pieces of identification information may be any pieces information that can be used to specify, respectively, the relative positions of the digital television display devices 151 to 153. The pieces of the identification information may also be pieces of information that can specify, for example, respectively, angles in the horizontal direction or angles in the depth direction of the digital television display devices 151 to 153, and the distances (how far it is) between the camera 301 and the digital television display devices 151 to 153.

The transmission controller 311 transmits, to the digital television display devices 151 to 153, a request for displaying different markers so that the digital television display devices 151 to 153 displays the markers.

When different markers are displayed, respectively, on the digital television display devices 151 to 153 that are combined with each other to display single video data, the input module 324 receives image data of the environment comprising the digital television display devices 151 to 153 acquired by the camera 301.

The specifying module 323 specifies relative positions of the digital television display devices 151 to 153 based on the markers contained in the image data received from the input module 324. The specifying module 323 is also capable of specifying display ranges for the respective digital television display devices 151 to 153 from the relative positions of the digital television display devices 151 to 153 and sizes of the display screens of the digital television display devices 151 to 153. A method for specifying the sizes of the display screens of the digital television display devices 151 to 153 is described later.

The display controller 322 displays a screen illustrating: display ranges of the single video data displayed, respectively, on the digital television display devices 151 to 153 specified based on the markers contained in the image data received by the input module 324; and a range of a virtual screen within which the single video data is output.

The receiving module 321 receives an operation on a screen currently displayed via the touch panel display 302. The receiving module 321 receives, for example, an operation to change the range of a virtual screen, within which the single video data is output, displayed on the touch panel display 302, and the display ranges of the single video data displayed, respectively, on the digital television display devices 151 to 153.

The setting module 325 sets display ranges of video data displayed, respectively, on the digital television display devices 151 to 153 in accordance with the relative positions specified by the specifying module 323 and the operation received by the receiving module 321. The setting module 325 derives a display position, a rotation angle, and a reduction and enlargement ratio of video data. Here, the display position, the rotation angle, and the reduction and enlargement ratio are for displaying single video data in accordance with the display ranges set to each of the digital television display devices 151 to 153.

The transmission controller 311 transmits, to each of the digital television display devices 151 to 153, a display instruction on video data. Here, the display instruction specifies at least one of a display position, a rotation angle, and a reduction and enlargement ratio that are derived by the setting module 325 and represents each of the display ranges of the single video data displayed on each of the digital television display devices 151 to 153. The display instruction on video data is an instruction specified based on an image of markers contained in image data generated by capturing by the camera 301 as described above.

There is no particular limitation on the size or other attributes of the display screens of the digital television display devices 151 to 153 constituting the display system according to the present embodiment. In order to acquire an image of markers by the camera 301 to recognize them, however, it is preferable to consider the attributes such as the size of the display screens of the digital television display devices 151 to 153 to display markers in suitable sizes. According to the present embodiment, the tablet 100 acquires, from the digital television display devices 151 to 153, attribute information for displaying markers before displaying them.

In other words, the transmission controller 311 transmits, to each of the digital television display devices 151 to 153, a transmission request (inquiry) for attribute information for causing the each of the digital television display devices 151 to 153 to display markers. The reception controller 312 then receives, from each of the digital television display devices 151 to 153, the attribute information comprising the size or resolution of the display screens of the each of the digital television display devices 151 to 153.

The specifying module 323 specifies display sizes of the markers displayed, respectively, on the digital television display devices 151 to 153 based on the size or resolution of the display screens of the digital television display devices 151 to 153. The transmission controller 311 then transmits a display request (information) for causing each of the digital television display devices 151 to 153 to display screens indicating different markers specified by the specifying module 323. Accordingly, the digital television display devices 151 to 153 display markers, respectively, having suitable sizes to be acquired by the camera 301 on their screens. The size and resolution of the display screens are also used to specify display ranges of the single video data for the respective digital television display devices 151 to 153.

Thereafter, the display instruction is transmitted to each of the digital television display devices in accordance with the above described procedure. In the present embodiment, the transmission controller 311 transmits the display instruction to each of the digital television display devices 151 to 153 when the transmission controller 311 has successfully identified, from the image data input by the input module 324, the same number of markers as that of the digital television display devices specified by using the attribute information received by the reception controller 312.

When the display instruction is received, each of the digital television display devices 151 to 153 displays video data for implementing a virtual screen.

The first digital television display device 151 comprises a configuration for implementing the display system in addition to a configuration of a typical television display device such as a display 356. In the first digital television display device 151, a CPU (not illustrated) executes various computer programs to implement a communication controller 351, a web browser 352, a WebSocket server 353, a WebSocket request processor 354, and digital television function middleware 355. The second digital television display device 152 and the third digital television display device 153 have the same configuration as that of the first digital television display device 151, thus the description thereof is omitted.

The communication controller 351 comprises a transmission controller 361 and a reception controller 362, and controls transmission and reception of data to and from communication devices such as the tablet 100.

The transmission controller 361 controls transmission of data to communication devices such as the tablet 100.

The reception controller 362 controls reception of data from a communication device such as the tablet 100.

The reception controller 362 also controls reception of video data output from the video image output device 203. The video image output device 203 may be connected to the digital television display devices via a communication interface, such as an HDMI, for transmitting video image on digital signals, or via a typical network such as a LAN for transmitting and receiving data.

The web browser 352 displays contents stored in the first digital television display device 151 and contents acquired from a server external to the first digital television display device 151. Various types of data such as a web page may be considered as the contents displayed on the web browser 352. In the present embodiment, a marker for identifying the first digital television display device 151 is one of the contents displayed.

The first digital television display device 151 according to the present embodiment stores, in a storage module (not illustrated), a web page containing a script for displaying the marker. When receiving arguments and a display request for displaying a marker, the first digital television display device 151 displays the marker in accordance with the arguments. In the present embodiment, the first digital television display device 151 receives arguments that are an identification number for identifying the digital television display devices and the display size of the marker.

The WebSocket server 353 is a computer program that functions as a server for establishing connection with other communication apparatuses (such as the digital television display devices 151 to 153) using the WebSocket protocol. In the present embodiment, the WebSocket server 353 is capable of, for example, controlling display of video data, displaying a marker on the web browser, and requesting acquisition of attributes (such as inch size and the number of pixels) after establishing connection using the WebSocket protocol. Although the present embodiment uses the WebSocket protocol as a method for establishing connection with other communication apparatuses, other methods may also be used.

The present embodiment uses, for example, UPnP as a method for recognizing an external apparatus (such as the tablet 100). The method is not limited to UPnP, but may be any method that is capable of acquiring an IP address of the external apparatus.

The WebSocket request processor 354 processes a request (instruction) transmitted from a communication apparatus (such as the digital television display devices 151 to 153) with which the first digital television display device 151 has established connection using the WebSocket server 353.

For example, when the reception controller 362 receives, from the tablet 100, a display instruction for changing at least one of a display position, a rotation angle, and an enlargement ratio that indicate a display range of the video data displayed on the first digital television display device 151, the WebSocket request processor 354 performs processing in accordance with the display instruction. In the present embodiment, the WebSocket request processor 354 calls the digital television function middleware 355 to perform the processing.

The digital television function middleware 355 has various functions such as decoding of video data for processing video data. The digital television function middleware 355 comprises, for example, a position control function 371, a rotation function 372, and a reduction and enlargement function 373. The position control function 371, the rotation function 372, and the reduction and enlargement function 373 according to the present embodiment are functions that are executable in accordance with an external instruction. In other words, the position control function 371, the rotation function 372, and the reduction and enlargement function 373 in the present embodiment are configured to be called from outside of the digital television display devices. This enables the digital television display devices to display video data corresponding to the respective positions thereof only by controlling display of the video image in accordance with the received instruction.

The position control function 371, the rotation function 372, and the reduction and enlargement function 373 controls the video data in accordance with a position, a rotation angle, and a reduction and enlargement ratio that are specified by the instruction received. In other words, the position control function 371 is a function of setting the display position of the video data such that the video data is displayed in a position specified by the instruction. The rotation function 372 is a function of setting a rotation angle of the video data such that the video data is displayed at a rotation angle specified by the instruction. The reduction and enlargement function 373 is a function of setting a reduction and enlargement ratio of the video data such that the video data is displayed at a reduction rate or an enlargement rate specified by the instruction.

In the present embodiment, the position control function 371, the rotation function 372, and the reduction and enlargement function 373 are opened to the public. This enables the tablet 100 connected to the digital television display devices via a network to control the display system in real time by a user's operation without using an apparatus dedicated to the digital television display devices.

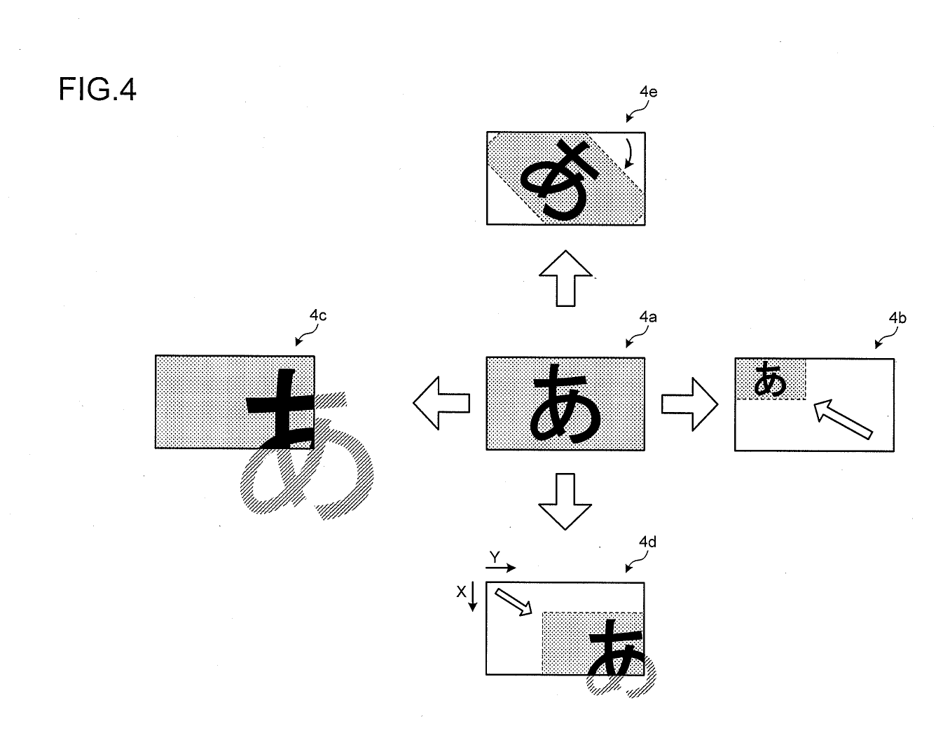

FIG. 4 is a diagram illustrating display examples of video data displayed by using the position control function 371, the rotation function 372, and the reduction and enlargement function 373.

Reference numeral 4a illustrates an initial display state, illustrating an example of received video data displayed in full-screen. The digital television display devices are capable of displaying video data in a reduced size by calling the reduction and enlargement function 373, as illustrated in reference numeral 4b. The digital television display devices are capable of displaying video data in an enlarged size by calling the reduction and enlargement function 373 as illustrated in reference numeral 4c.

In the same manner, the digital television display devices are capable of displaying video data shifted in at least one direction of X coordinate direction and Y coordinate direction from a normal display range by calling the position control function 371 as illustrated in reference numeral 4d.

Furthermore, the digital television display devices are capable of displaying rotated video data by calling the rotation function 372 as illustrated reference numeral 4e.

The display 356 displays video data input from the video image output device 203 by using at least one of the position control function 371, the rotation function 372, and the reduction and enlargement function 373.

Each of the digital television display devices 151 to 153 according to the present embodiment is capable of displaying a unique marker depending on a request from the tablet 100.

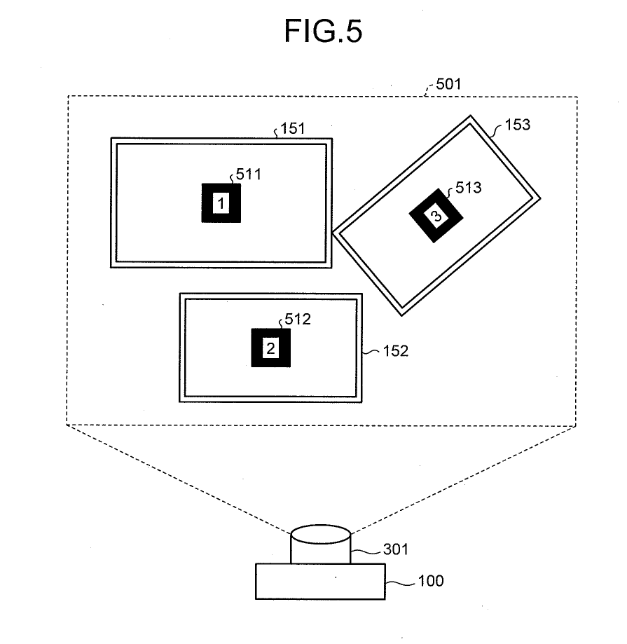

FIG. 5 is a schematic diagram illustrating a case in which the digital television display devices 151 to 153 display markers. As illustrated in FIG. 5, when the digital television display devices 151 to 153 display markers, they display markers indicating different numbers, thereby enabling the tablet 100 to recognize which marker corresponds to which digital television display device. Thus, the tablet 100 specifies numbers as arguments displayed on markers before the tablet 100 sends a display request for displaying markers to the digital television display devices 151 to 153.

The tablet 100 adjusts the orientation of the camera 301 such that all markers 511 to 513 are contained in an image acquiring range 501 of the camera 301, and acquires an image of the markers 511 to 513 by the camera 301.

The specifying module 323 performs image processing on acquired image data, thereby specifying relative positions of the digital television display devices 151 to 153.

According to the present embodiment, the processing described above can reduce a load on a measuring process of positions of the digital television display devices 151 to 153. Although FIG. 5 illustrates an example in which markers are displayed in the middle of the screens, markers may be displayed in full screen, or displayed at the four corners of each screen so that the tablet 100 will more easily recognize the positions of the digital television display devices 151 to 153, or recognize the positions even when the screens are overlapped.

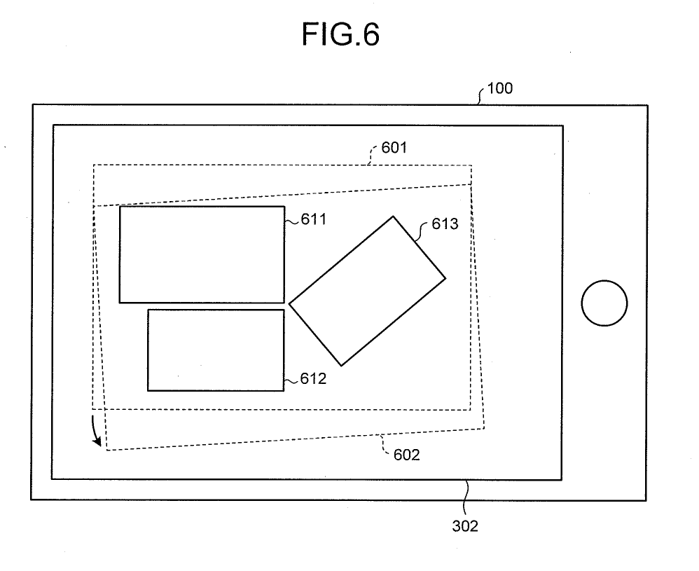

FIG. 6 is a diagram illustrating an example of a setting screen displayed on the touch panel display 302 of the tablet 100, and illustrating how the video data is displayed in the display system. The screen example in FIG. 6 illustrates display regions 611 to 613 for the respective digital television display devices in accordance with the relative positions of the digital television display devices specified by the specifying module 323. The user can adjust the display regions 611 to 613 and a virtual output range 601 of the video data displayed on the touch panel display 302.

For example, the receiving module 321 receives an operation to change the virtual output range 601 in which video data is displayed, to a virtual output range 602. In accordance with the operation, the transmission controller 311 of the tablet 100 transmits, to the digital television display devices 151 to 153, an instruction to change a display position, an enlargement ratio, and a rotation angle at which the video data is displayed.

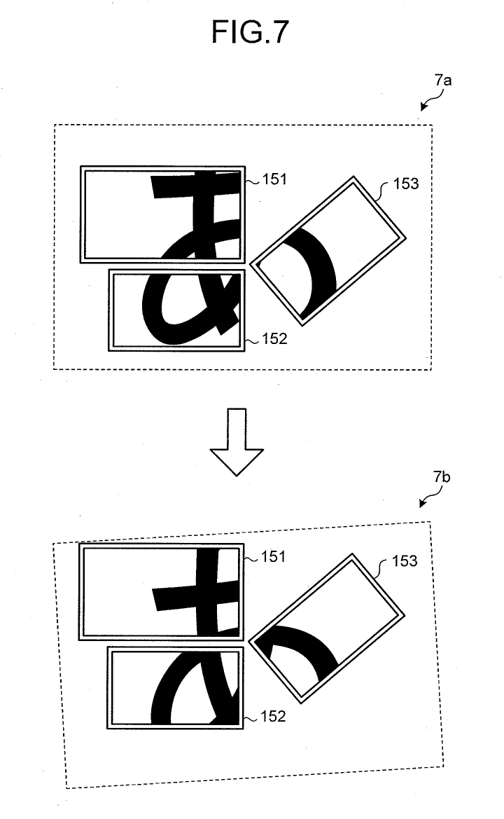

FIG. 7 is a diagram illustrating an example of the digital television display devices that change display modes of the video data according to an instruction from the tablet 100.

Reference numeral 7a illustrates the digital television display devices 151 to 153 that display partial regions of the video data corresponding to the respective positions of the digital television display devices 151 to 153 in accordance with the virtual output range 601 displayed on the tablet 100 illustrated in FIG. 6.

When the virtual output range 601 is changed to the virtual output range 602 by a user's operation, the tablet 100 transmits, to the digital television display devices 151 to 153, an instruction to specify a position, an enlargement ratio and a rotation angle at which the video data is displayed. The digital television display devices 151 to 153 display video data illustrated in reference numeral 7b.

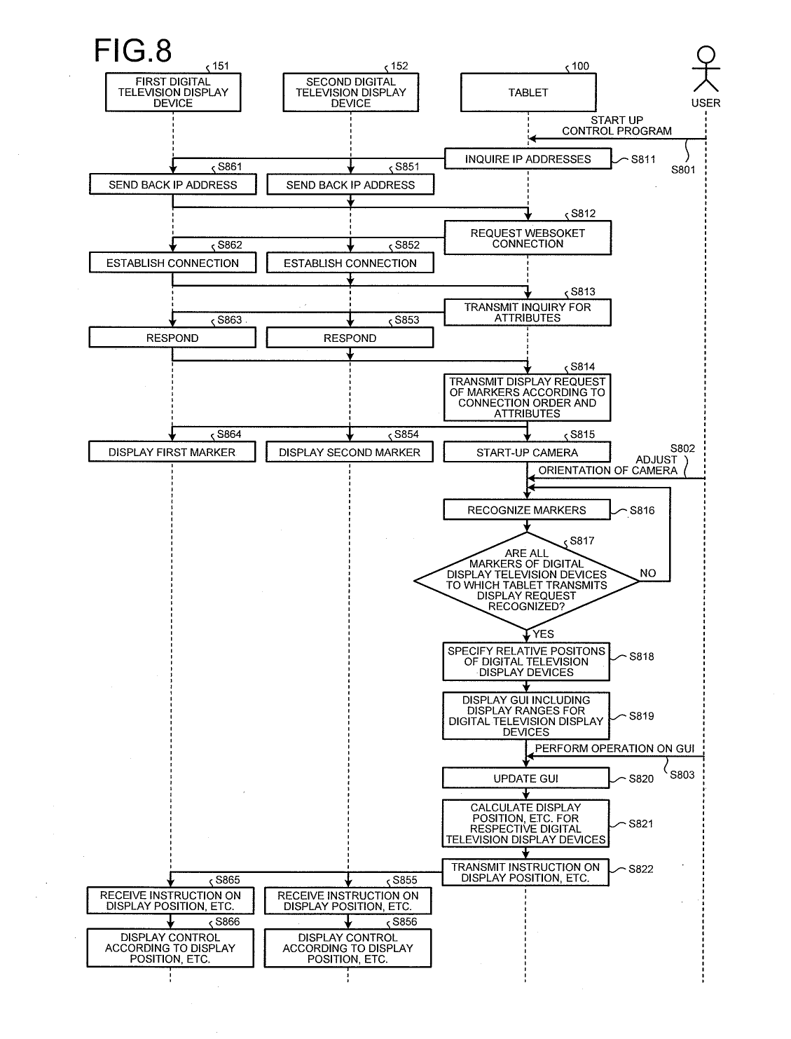

Next, described is processing for displaying video data in the display system according to the present embodiment. FIG. 8 is a flowchart illustrating the procedure for displaying the video data in the display system in the present embodiment.

First, a user performs an operation to start up the control program 303 on the tablet 100 (S801).

The tablet 100 executes the control program 303 in accordance with the start-up operation. The transmission controller 311 of the control program 303 thus executed transmits an inquiry for IP addresses to the digital television display devices 151 to 153 that are connected with the tablet 100 via the router 201 (S811). Although an example of FIG. 8 only illustrates the first digital television display device 151 and the second digital television display device 152 in order to simplify the explanation, the third digital television display device 153 also performs the same processing as that of the other digital television display devices.

In response to the inquiry for IP addresses, the transmission controller 311 of the first digital television display device 151 transmits its IP address to the tablet 100 (S861). In the same manner, the transmission controller 311 of the second digital television display device 152 also transmits its IP address to the tablet 100 (S851).

After receiving the IP addresses, the tablet 100 transmits a connection request on the WebSocket connection to the IP addresses thus received (S812).

The WebSocket server 353 of the first digital television display device 151 establishes connection with the tablet 100 using the WebSocket protocol in accordance with the received connection request (S862). In the same manner, the WebSocket server 353 of the second digital television display device 152 establishes connection with the tablet 100 using the WebSocket protocol in accordance with the received connection request (S852).

After connection is established, the transmission controller 361 of the tablet 100 transmits an inquiry for attributes to the digital television display devices with which the tablet 100 has established connection (S813). The attributes of the digital television display devises are necessary for the camera 301 to recognize the digital television display devices, and comprise at least the size, resolution, and other attributes of the display screens of the digital television display devices.

In response to the received inquiry, the transmission controller 361 of the first digital television display device 151 transmits attribute information comprising the size and resolution of the display screen of the first digital television display device 151 (S863). In the same manner, the transmission controller 361 of the second digital television display device 152 transmits attribute information comprising the size and resolution of the display screen of the second digital television display device 152 in response to the received inquiry (S853).

The transmission controller 311 of the tablet 100 transmits a display request for displaying markers in accordance with the order of connection and the attribute information to the first digital television display device 151 and the second digital television display device 152 (S814). Although numbers that are assigned in accordance with the order of connection are displayed as the markers in the present embodiment, information displayed as the markers may only be unique information that can identify the digital television display devices. In the present embodiment, the tablet 100 requests the digital television display devices to display markers in accordance with attributes (that is, sizes and resolution of the display screens). In other words, the tablet 100 requests the digital television display devices to display markers in consideration of the attributes (that is, sizes and resolution of the display screens) so that the camera 301 can easily acquire an image of the markers.

The display controller 322 of the first digital television display device 151 displays a first marker (comprising an, identification number “1”) in accordance with the received display request (S864). In the same manner, the display controller 322 of the second digital television display device 152 displays a second marker (comprising an identification number “2”) in accordance with the received display request (S854). In the present embodiment, it is assumed that the tablet 100 requests the first digital television display device 151 to display a marker indicating the identification number “1”, and the second digital television display device 152 to display a marker indicating the identification number “2” in accordance with the order of connection.

The control program 303 of the tablet 100 controls the camera 301 to start up (S815). Thereafter, the user adjusts the orientation of the camera 301 that has started up (S802).

The specifying module 323 performs image processing on image data input from the camera 301 to recognize markers contained in the image data (S816). The specifying module 323 determines whether it has recognized all the markers of the digital television display devices to which the tablet 100 transmits the display request (S817). When the specifying module 323 determines that it has not recognized all the markers (No at S817), the process returns to S816.

When the specifying module 323 determines that it has recognized all the markers of the digital television display devices to which the tablet 100 transmits the display request (Yes at S817), the specifying module 323 specifies relative positions of the digital television display devices based on the image data (S818).

The display controller 322 displays a graphic user interface (GUI) including display ranges based on the specified relative positions of the digital television display devices (S819).

The receiving module 321 receives an operation on the GUI from the user, that is, an operation to change the display ranges of the image data displayed on the respective digital television display devices (S803).

The display controller 322 updates the GUI in accordance with the received operation to change the display ranges of the image data displayed on the respective digital television display devices (S820).

In other words, in accordance with the operation to change the display ranges, the specifying module 323 first calculates the initial position of a virtual screen, and then specifies the display ranges for the digital television display devices. This processing is performed every time the user performs the operation to change the display ranges, and the GUI is updated, accordingly.

The setting module 325 calculates a display position, a rotation angle, and a reduction and enlargement ratio of video data corresponding to the display ranges for the respective digital television display devices that are specified by the relative positions specified by the specifying module 323 and specified by the operation received by the receiving module 321 (S821).

The transmission controller 311 transmits, to each of the digital television display devices, a display request of the video data and a display instruction that specifies a display position, a rotation angle, and a reduction and enlargement ratio that indicate the display ranges of the video data (S822).

The reception controller 362 of the first digital television display device 151 receives, from the tablet 100, the display request of the video data, and the display instruction that specifies a display position, a rotation angle, and a reduction and enlargement ratio that indicate the display ranges of the video data (S865). The display 356 of the first digital television display device 151 displays the video data in accordance with the display position, the rotation angle, and the reduction and enlargement ratio that have been specified by the received instruction (S866).

In the same manner, the reception controller 362 of the second digital television display device 152 receives, from the tablet 100, a display request of the video data, and a display instruction that specifies a display position, a rotation angle, and a reduction and enlargement ratio that indicate the display ranges of the video data (S855). The display 356 of the second digital television display device 152 displays the video data in accordance with the display position, the rotation angle, and the reduction and enlargement ratio thus received (S856).

In the present embodiment, every time the GUI is updated, the tablet 100 transmits a display position, a rotation angle, and a reduction and enlargement ratio to each of the digital television display devices. That is, every time the tablet 100 receives an operation from the user, the tablet 100 updates the virtual screen, transmits a display position, a rotation angle, and a reduction and enlargement ratio according to the update, and updates the display of the digital television display devices. In the present embodiment, as described above, video data displayed in the display system can be updated on a real-time basis corresponding to an operation performed on the tablet 100.

In the present embodiment, the digital television display devices provide a function of controlling video data (such as a function of changing a display position, a rotation angle, and a reduction and enlargement ratio) to external devices such as the tablet 100 via a server installed in the digital television display devices. This enables the user to change the display position and size of the virtual screen in real time in accordance with, for example, a user's operation performed on the tablet 100.

In the present embodiment, the tablet 100 acquires attribute information on the digital television display devices, and requests the digital television display devices to display markers in accordance with the attribute information. The tablet 100 then acquires an image of the markers displayed in accordance with the request, thereby enabling the tablet 100 to easily recognize relative positions of the digital television display devices. In the present embodiment, even when digital television display devices having different display sizes are combined with each other to display video image, the tablet 100 easily recognizes the relative positions by acquiring attributes of the digital television display devices. When the position of a digital television display device is shifted not only in the vertical or the horizontal direction, but in the depth direction, the tablet 100 is capable of recognizing the relative positions of the digital television display devices in the depth direction because the tablet 100 has recognized the display size of the digital television display device.

Although the present embodiment describes an example in which a user operates a GUI to change display ranges for the respective digital television display devices, the embodiment is not limited to the method using the GUI. The display ranges for the respective digital television display devices, that is, a virtual screen may be controlled in accordance with recognition processing on image data captured by the camera 301, or detection results from certain sensors. For example, a digital display system comprising a plurality of digital television display devices is installed on a street as signage, and a camera acquires an image of the street to generate image data from which a travelling direction and the face of a passerby are detected. The display system controls the virtual screen displayed in accordance with the travelling direction of the face of the passerby thus detected (for example, the display system controls the digital television display devices to display a product on their screens and to move the screens so that the passerby can view the product along the way).

The digital television display devices 151 to 153 according to the present embodiment provide a function of controlling video data to external devices via a server installed in the digital television display devices 151 to 153. This can change display ranges of the video data on a real-time basis depending on, for example, a user's operation (in other words, this can change the position and size of a virtual screen implemented on the digital television display devices 151 to 153).

In the present embodiment, the tablet 100 causes the digital television display devices 151 to 153 to display markers in accordance with attribute information acquired from the digital television display devices 151 to 153. This makes it easier for the tablet 100 to recognize the markers, thereby enabling the tablet 100 to easily recognize the relative positions of the digital television display devices 151 to 153. This also enables the tablet 100 to easily specify display ranges of video data displayed on the respective digital television display devices 151 to 153.

Because the tablet 100 acquires screen sizes of the digital television display devices as attribute information, the tablet 100 can recognize the relative positions of the digital television display devices in the depth direction from the sizes of markers indicated in image data captured by the camera 301. This enables the specifying module 323 according to the present embodiment to recognize, for example, the display positions, tilt, and orientation of the digital television display devices disposed three-dimensionally.

The tablet 100 according, to the present embodiment transmits, to a plurality of digital television display devices, a display position, a rotation angle, and a reduction and enlargement ratio that specify display ranges of video data displayed on the respective digital television display devices in accordance with image data, thereby implementing a virtual screen in a display system. This can reduce a setting load on a user to implement the virtual screen and a processing load on the video image output device 203. In other words, the video image output device 203 outputs video data without processing the video data by itself, thereby reducing cost of the video image output device 203.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device configured to communicate with display devices configured to be combined with each other to display single image data, the electronic device comprising:
an input controller configured to receive image data comprising both images of the display devices and images of identification information displayed on screens of the display devices; and
a transmitter configured to transmit a first instruction for assigning at least one of display positions, rotation angles, and reduction and enlargement ratios of display ranges of the single image data to be displayed on the display devices, the first instruction being determined by using the image data.

2. The electronic device of claim 1, wherein the transmitter is configured to transmit information to cause each of the display devices to display an identification screen that is different depending on the display devices.

3. The electronic device of claim 2, further comprising:
a receiver configured to receive, from at least one of the display devices, first information comprising a size or resolution of a display screen of the at least one of the display devices, wherein
the transmitter is configured to transmit information to cause the at least one of the display devices to display the identification screen determined based on the first information.

4. The electronic device of claim 3, wherein the transmitter is configured to transmit, when the transmitter has successfully identified same number of the pieces of the identification information as number of the display devices specified by the first information, the first instruction.

5. The electronic device of claim 1, further comprising:
a display controller configured to display a first screen indicative of a range within which the single image data can be output and the display ranges of the single image data displayed, respectively, on the display devices, the display ranges being specified based on identification screens in the image data; and
a receiving controller configured to receive an operation to change the range within which the single image data is output, or the display ranges of the single image data, wherein
the transmitter is configured to transmit the first instruction that is specified in accordance with the operation received by the receiving controller.

6. A display device comprising:
a first receiver configured to receive single image data;
a second receiver configured to receive, from an electronic device, a first instruction for assigning at least one of display positions, rotation angles, and reduction and enlargement ratios of display ranges of the single image data displayed on the display devices; and
a display configured to display, based on the first instruction, the single image data based on at least one of a display position of the single image data, a rotation angle at which image information is rotated, and a reduction and enlargement ratio at which the image information is displayed.

7. A method of displaying data using display devices comprising:
inputting, when pieces of identification information are displayed on screens of display devices configured to be combined with each other to display single image data, image data comprising both images of the display devices and images of pieces of the identification information; and
transmitting a first instruction for assigning at least one of display positions, rotation angles, and reduction and enlargement ratios of display ranges of the single image data to be displayed on the display devices, the first instruction being determined by using the image data.

8. The method of claim 7, wherein the transmitting comprises transmitting information to cause display devices to display, respectively, the identification screens that are different depending on the display devices.

9. The method of claim 8, further comprising:
receiving, from at least one of the display devices, first information comprising a size or resolution of a display screen of the at least one of the display devices, wherein
the transmitting comprises transmitting information to cause the at least one of the display devices to display a corresponding identification screen determined based on the first information.

10. The method of claim 9, wherein the transmitting comprises transmitting, when same number of pieces of the identification information as number of the display devices specified by the first information has successfully been identified from the image data input by the input controller, the first instruction.

11. The method of claim 7, further comprising:
displaying a first screen indicative of a range within which the single image data can be output and the display ranges of the single image data displayed, respectively, on the display devices, the display ranges being specified based on identification screens in the image data; and
receiving an operation to change the range within which the single image data is output, or the display ranges of the single image data; wherein
the transmitting comprises transmitting the first instruction that is specified in accordance with the operation received by the receiving.

12. A computer program product having a non-transitory computer readable medium including programmed instructions, wherein the instructions, when executed by a computer, cause the computer to perform:
inputting, when pieces of identification information are displayed on screens of display devices configured to be combined with each other to display single image data, image data comprising both images of the display devices and images of pieces of the identification information; and
transmitting a first instruction for assigning at least one of display positions, rotation angles, and reduction and enlargement ratios of display ranges of the single image data to be displayed on the display devices, the first instruction being determined by using the image data.

13. The computer program product of claim 12, wherein the transmitting comprises transmitting information to cause the display devices to display, respectively, the identification screens that are different depending on the display devices.

14. The computer program product of claim 13, further comprising:
receiving, from at least one of the display devices, first information comprising a size or resolution of a display screen of the at least one of the display devices, wherein
the transmitting comprises transmitting information to cause each of the at least one of the display devices to display a corresponding identification screen determined based on the first information.

15. The computer program product of claim 14, wherein the transmitting comprises transmitting, when same number of the pieces of the identification information as number of the display devices specified by the first information received by the receiver has successfully been identified from the image data input by the input controller, the first instruction.

16. The computer program product of claim 12, further comprising:
displaying a first screen indicative of a range within which the single image data can be output and the display ranges of the single image data displayed, respectively, on the display devices, the display ranges being specified based on identification screens in the image data; and
receiving an operation to change the range within which the single image data is output, or the display ranges of the single image data; wherein
the transmitting comprises transmitting the first instruction that is specified in accordance with the operation received by the receiving.
